(19) United States
(12) Patent Application Publication
(10) Pub. No.: US 2024/0096329 A1
(43) Pub. Date: Mar. 21, 2024

(54) QA TV-MAKING MILLIONS OF CHARACTERS ALIVE

(71) Applicant: TCL RESEARCH AMERICA INC., San Jose, CA (US)

(72) Inventor: Haohong WANG, San Jose, CA (US)

(21) Appl. No.: 17/994,726

(22) Filed: Nov. 28, 2022

Related U.S. Application Data
(60) Provisional application No. 63/408,607, filed on Sep. 21, 2022.

(51) Int. Cl. G10L 15/26; G10L 25/63

(52) U.S. Cl. CPC G10L 15/26; G10L 25/63

(57) ABSTRACT

A method and device for interaction are provided. The method includes: in response to a user starting a conversation, detecting a current program watched by the user, obtaining an input by the user and identifying a character that the user talks to based on the input, retrieving script information of the detected program and a cloned character voice model corresponding to the identified character, generating a response based on the script information corresponding to the identified character, and displaying the generated response using the cloned character voice model corresponding to the identified character to the user.

### CROSS-REFERENCE TO RELATED APPLICATION

The present application claims the priority of U.S. Provisional Patent Application No. 63/408,607, filed on Sep. 21, 2022, the entire contents of which are incorporated herein by reference.

### FIELD OF THE DISCLOSURE

The present disclosure relates to the field of digital assistance technologies and, more particularly, relates to a method and device for interaction.

### BACKGROUND

For decades, television (TV) is a most influential entertainment device for human beings with the nature of passive experiences. Many technologies and innovations have been deployed in the field to enhance this experience. A frequency of user interaction and/or the clicks on the keys of the remote control is considered as a basic metric to evaluate the performance of a TV, based on an assumption that TV is lean back experience that needs as less user interaction as possible.

### BRIEF SUMMARY OF THE DISCLOSURE

One aspect of the present disclosure provides a method for interaction. The method includes: in response to a user starting a conversation, detecting a current program watched by the user, obtaining an input by the user and identifying a character that the user talks to based on the input, retrieving script information of the detected program and a cloned character voice model corresponding to the identified character, generating a response based on the script information corresponding to the identified character, and displaying the generated response using the cloned character voice model corresponding to the identified character to the user.

Another aspect of the present disclosure provides a device for interaction, including a memory and a processor coupled to the memory. The processor is configured to perform a plurality of operations including: in response to a user starting a conversation, detecting a current program watched by the user, obtaining an input by the user and identifying a character that the user talks to based on the input, retrieving script information of the detected program and a cloned character voice model corresponding to the identified character, generating a response based on the script information corresponding to the identified character, and displaying the generated response using the cloned character voice model corresponding to the identified character to the user.

### BRIEF DESCRIPTION OF THE DRAWINGS

The following drawings are merely examples for illustrative purposes according to various disclosed embodiments and are not intended to limit the scope of the present disclosure.

FIG. 1 is a block diagram of an exemplary computing system according to some embodiments of the present disclosure.

FIG. 2 illustrates an exemplary interaction process 200 according to some embodiments of the present disclosure.

FIG. 3 illustrates an example of user talking to Dracular of the movie “Monster Family.”

FIG. 4 illustrates an example of system architecture of QA TV according to some embodiments of the present disclosure.

### DETAILED DESCRIPTION

Reference will now be made in detail to exemplary embodiments of the invention, which are illustrated in the accompanying drawings. Hereinafter, embodiments consistent with the disclosure will be described with reference to the drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

Nowadays, a sensing-based automatic user identification learning approaches are studied. Personalized recommendations can speed up the user interaction process in front of TVs. The TV content layout structure and organization are explored. A zoomable user interaction mechanism enables a much quicker content search and selection process. The object-level access and interaction tasks during TV watching are investigated, so that user can handle experiences like TV shopping and information retrieval in real time manner. An extremely simple experience called Binary TV completely saves user from interacting with the complex remote controls, in which the user only need to make immediate binary (yes or no) decision when a query comes from TV. User is allowed to make wishes (e.g., change an arc of a character, make a choice for a character, add a new event, etc.) at any time the user wants. The TV is required to entertain the wish of the user by dynamically guide the storytelling engine to the desired direction. The user interaction capability is further extended from only making wishes outside the TV to being able to experience (via their own avatar) and explore inside the 3D story scenes.

The present disclosure provides a method and device for interaction with users. The disclosed method and/or device can be applied in any proper occasions where interaction is desired.

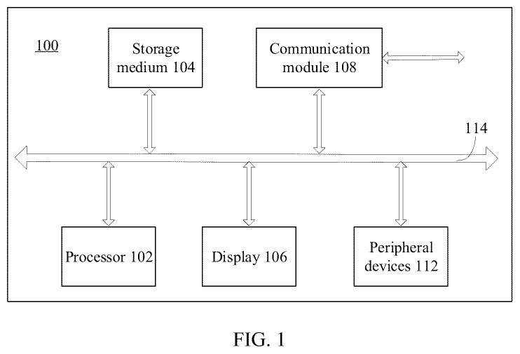

FIG. 1 is a block diagram of an exemplary computing system/device capable of implementing the disclosed interaction method according to some embodiments of the present disclosure. As shown in FIG. 1, computing system 100 may include a processor 102 and a storage medium 104. According to certain embodiments, the computing system 100 may further include a display 106, a communication module 108, peripheral devices 112, and one or more bus 114 to couple the devices together. Certain devices may be omitted and other devices may be included.

Processor 102 may include any appropriate processor(s). In certain embodiments, processor 102 may include multiple cores for multi-thread or parallel processing, and/or graphics processing unit (GPU). Processor 102 may execute sequences of computer program instructions to perform various processes, such as a one-click filmmaking program, etc. Storage medium 104 may be a non-transitory computer-readable storage medium, and may include memory modules, such as ROM, RAM, flash memory modules, and erasable and rewritable memory, and mass storages, such as CD-ROM, U-disk, and hard disk, etc. Storage medium 104 may store computer programs for implementing various processes, when executed by processor 102. Storage medium 104 may also include one or more databases for storing certain data such as text script, library data, training data set, and certain operations can be performed on the stored data, such as database searching and data retrieving.

The communication module 108 may include network devices for establishing connections through a network. Display 106 may include any appropriate type of computer display device or electronic device display (e.g., CRT or LCD based devices, touch screens). The peripheral devices 112 may include additional I/O devices, such as a keyboard, a mouse, and so on.

In operation, the processor 102 may be configured to execute instructions stored on the storage medium 104 and perform various operations related to an interaction method as detailed in the following descriptions.

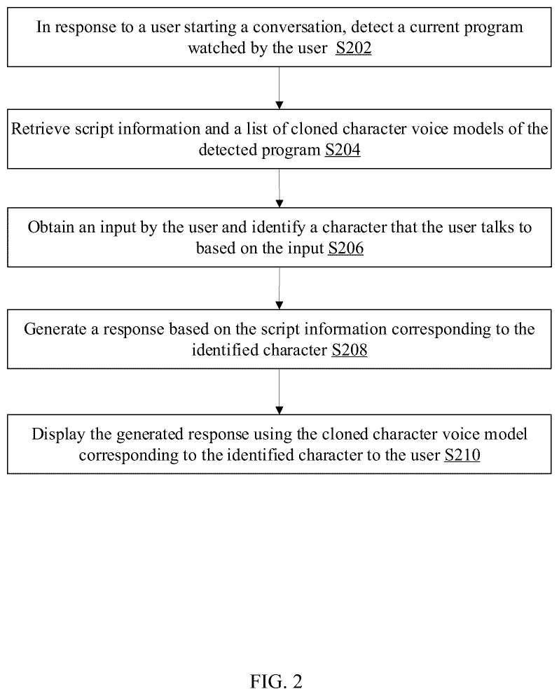

FIG. 2 illustrates an exemplary interaction process 200 according to some embodiments of the present disclosure. The process 200 may be implemented by an interaction device which can be any suitable computing device/server having one or more processors and one or more memories, such as computing system 100 (e.g., processor 102). The interaction device may include a television (TV), a smart phone, a tablet, a computer, internet of thing (IoT) device (e.g., VR/AR, radio, smart speaker, etc.), or another electronic device that can generate audio or visual programs to the user. The television may include a question and answer (QA) TV, a smart TV, or a mobile-based TV. It should be understood that the “TV” here is not limited to television, but refers to all video entertainment system that also include projection-based, PC-based, set-top-box/stick based, VR/AR based, and mobile-based solutions, and all audio entertainment system that includes smart speaker, radio, smart toys, etc.

As shown in FIG. 2, the interaction method consistent with embodiments of the present disclosure includes following processes.

At S202, in response to a user starting a conversation, a current program watched by the user is detected.

In some embodiments, the user may start the conversation by asking a question using a microphone either on a television (TV) (if far-filed voice feature is available) or connected to TV (can be on a remote control of the TV, or using an external device such as a mobile phone, joystick, or IoT device).

In some embodiments, the program watched by the user may include a movie, a TV show, a TV series, a TV drama, a TV program, a comedy, a soap opera, or a news program, etc.

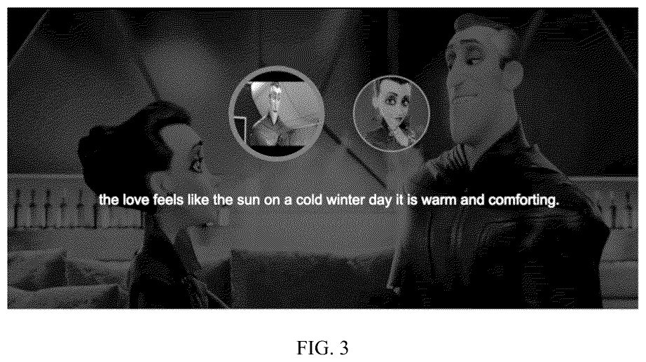

FIG. 3 illustrates an example of user talking to Dracular of the movie “Monster Family.” For example, as shown in FIG. 3, when the user watches the movie “Monster Family” and wants to talk to a character on the TV, the user can say “Dracular, what the love feel like,” or pause the TV and select a character showing on the TV to ask.

There are hundreds of characters appearing on each of the hundreds of TV programs every day. The program currently watched by the user is searched from hundreds of TV programs using the database. The database is configured to store the hundreds of TV programs and millions of characters with the script information and cloned character voice models of each character.

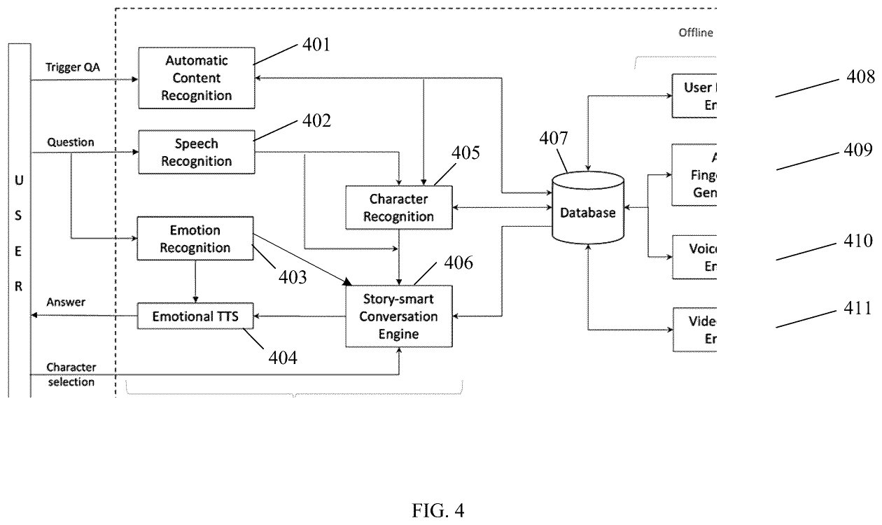

FIG. 4 illustrates an example of system architecture of question and answer (QA) TV according to some embodiments of the present disclosure. As shown in FIG. 4, the user can interact with the TV using a very simple interaction model, that is, at anytime user can talk to a specific character of the TV program in playback. The system in FIG. 4 can perform the method for interaction consistent with the embodiments of the present disclosure.

As shown in FIG. 4, major components of the QA TV are demonstrated in a dash box. It should be understood that it is a conceptual diagram that does not require all components to be in a physical TV box, instead, these components could be implemented either in the TV software, or as a cloud services, or as a service provided by another device, that the TV software can access and use. The modules on the left (e.g., automatic content recognition (ACR) module 401, speech recognition engine 402, emotion recognition 403, emotional text-to-speech system 404, character recognition engine 405, and story-smart conversation engine 406) are recommended as “online modules” which require the system to provide immediate computational resources and generate instant responses. The modules on the right (e.g., user profiling engine 408, ACR fingerprint generator 409, voice clone engine 410, and video script engine 411) are recommended as “offline modules” which allows offline computation or process that can does not require instant outcome. The recommendations are from conceptual point of view, which does not require the implementation to strictly follow, in other words, in the practical implementation, the modules can be determined whether online or offline based on the practical condition of the system setup and associated requirements.

In some embodiments, an automatic content recognition (ACR) module 401 may detect which program is currently on by retrieve a database 407 of ACR fingerprint generator 409. In some embodiments, if the user is watching a video on demand, the system can detect the program currently watched by the user without using the ACR module 401.

In some embodiments, the ACR module 401 is used to determine what program the user is currently watching based on a fingerprint library and a real time matching algorithm to find out the closest fingerprint detected in the library that matches with the current program.

In some embodiments, to recognize the TV program in real time, a library of ACR fingerprint generator 409 is required to be built for hundreds and millions of titles and programs. The larger the library the more supportable program the system is. The ACR module 401 can be either based on audio or visual fingerprints depending on how the system is implemented.

In some embodiments, to customize user experience, the system may be configured to understand a preference of the user through a pattern of interactivities of the user with the TV. A user profiling engine 408 may process the user behavior in front of the TV (e.g., how frequent the user interacts with the character, which types of programs and characters the user interacts the most, etc.) being collected, build profiles for the user, and model the behavior and preferences of the user.

At S204, script information and a list of cloned character voice models of the detected program are retrieved.

Retrieving the script information and the list of the cloned character voice models is critical to make millions of characters alive in the interaction method consistent with the present disclosure. If the script information or the list of the cloned character voice models is missing, the system may be configured to let user aware that the current program is not a QA TV ready program.

In some embodiments, to represent the characters in the program, a cloned voice (or a sound nearly-same voice) may be secured ahead of time. With the latest advances of voice synthesis technology, a voice clone engine 410 can synthesize a voice of a person from only a few audio samples. For characters in the program that has very less screening time, if voice clone cannot generate a voice model to match the voice of the character, then the system can select a voice model from the library that sounds closest to the available audio samples.

In some embodiments, a video script engine 411 is a component in the system where the story comes from. The script can be either the original screenplay or a rewritten story plot according to the requirement of a story-smart conversation engine 406. For scripted program, the script is easy to be obtained. However, for unscripted program, the script would not be available during the live broadcasting time although possible to be ready by the time of the re-run. For a program without a script in the database, the story-smart conversation engine 406 may not be able to generate answer for the question of the user in an acceptable quality standard.

In some embodiments, the story-smart conversation engine 406 may include an artificial intelligence (AI) based story-smart conversation engine.

At S206, an input by the user is obtained, and a character that the user talks to is identified based on the input.

In some embodiments, the step S206 may be performed before, after, or at a same time as the step S204 is performed.

In some embodiments, the cloned character voice model corresponding to the identified character may be retrieved from the list of the cloned character voice models of the detected program after the character that the user talks to is identified. In some embodiments, after the character is identified, only the cloned character voice model corresponding to the identified character is retrieved from the database, where the list of the cloned character voice models of the detected program may not be retrieved.

In some embodiments, the input includes a voice input by the user. The voice input is converted into a text, and the character that the user talks to is identified based on the text. In some embodiments, the input may include a text input, an image input, a gesture input, etc.

In some embodiments, the input by the user includes a question or answer of the user. As shown in FIG. 4, when the input is a voice input, the voice input may go through a speech recognition engine 402 to convert the voice into text. The character recognition engine 405 may identify the character the user is talking to from the text generated.

In some embodiments, if no character is detected, the system can either use a last character that the user is in conversation, or popup a window to let the user specify which character the user is interacting with.

In some embodiments, the speech recognition engine 402 may convert the conversation of the user from voice into text. The text is sent to both the character recognition engine 405 and a story-smart conversation engine 406.

In some embodiments, the character recognition engine 405 is used to detect the character the user is approaching. If the name of the character is included in the conversation, for example, “Emma, why are you crying,” the name of the character caught as “Emma” may be verified with the metadata of the program detected by the ACR to make sure it is in the list of story characters. If the system is unsure about the character, the system may confirm with the user with a list of possible characters until the character is identified.

At S208, a response is generated based on the script information corresponding to the identified character.

In some embodiments, once the character is determined, the story-smart conversation engine 406 may generate the response based on the script retrieved from the database. For example, as shown in FIG. 3, when the user asks “Dracular, what the love feel like,” the response generated based on the script information corresponding to the character “Dracular” of the movie “Monster Family” is that “the love feels like the sun on a cold winter day it is warm and comforting.”

In some embodiments, the story-smart conversation engine 406 empowers the conversation functionalities of the system. In some embodiments, a context-based QA system may be used. For example, there is a script available from every character's perspective, the same algorithm may be applied to these scripts to generate conversation system for every character.

At S210, the generated response is displayed using the cloned character voice model corresponding to the identified character to the user.

In some embodiments, the response generated by the story-smart conversation engine 406 may go through an emotional text-to-speech (TTS) system 404 that utilizes the cloned character voice (or a voice selected from the database that close enough to the character voice) and generate a final answer to user. For example, the character that the user is talking to can respond the user with an answer using the voice of the character.

In some embodiments, the generated response may be displayed in an audio format only. In some embodiments, the generated response may be displayed in both audio and visual formats. For example, the generated response may be played using the cloned character voice model with an image of the character, or the generated response may be played using the cloned character voice model with an animation or video where the character is talking with facial expression and body movements according to the generated response.

For example, as shown in FIG. 3, the program currently watched by the user is the movie “Monster Family.” When the user starts a conversation, the movie is paused with a static image shown in a display. Two candidate characters of the movie are shown in two circles. As described above, the character that the user talks to is determined as Dracular, the circle of Dracular is highlighted. The generated response is displayed as a text shown in the bottom of the two circles. The generated response is also spoken using the cloned character voice of Dracular to the user. After the generated response is displayed, the user may continue to talk to Dracular, or may switch to talk to the other character shown in the circle by a voice input or a selection operation. If the user switches to talk to the other character, the circle of Dracular is not highlighted, while the circle of the other character is highlighted. For a same question asked by the user, the content of the generated responses by Dracular and by the other character of the movie may be different.

In some embodiments, a current emotion of the user is detected by an emotion recognition engine 403, and an emotion of the displayed response using the cloned character voice model is adjusted based on the detected emotion of the user. In some embodiments, the detected emotion of the user may be processed in the emotional TTS system 404.

In some embodiments, the emotion recognition engine 403 is used to determine the current emotion of the user based on the conversation input of the user.

In some embodiments, the emotional TTS system 404 may decide the emotional reaction of the character corresponding to the emotion detected from the user. In some embodiments, empathetic dialog with position emotion elicitation similar to that of emotional support between humans can be generated. The emotion of response may be adjusted to ensure smooth emotion transition along with the whole dialog flow. If a starting emotion state of the user is positive, an emotional state of the response may be aligned with the starting emotion state to keep the positive emotion of the user in the whole dialogue. If the starting emotion state of the user is negative, the emotional state of the response may be expressed empathy at an initial stage of the dialogue, and progressively transmitted to positive emotional state to elicit the positive emotion of the user. Once the emotional component is determined, the TTS can be enhanced to become an emotional TTS.

In some embodiments, the current emotion of the user detected by the emotion recognition engine 430 may be transmitted to the story-smart conversation engine 406. The story-smart conversation engine 406 may generate a plurality of candidate responses with different emotional states based on the input of the user. After the story-smart conversation engine 406 receives the current emotion of the user from the emotion recognition engine 430, the story-smart conversation engine 406 may select one of the plurality of candidate responses based on the current emotion of the user. For example, the plurality of candidate responses may include responses with happy emotional state, calm emotional state, and sympathy emotional state. In response to the current emotion of the user being happy or positive, the story-smart conversation engine 406 selects the response with happy emotional state as the generated response and sends the selected response to the TTS system 404.

In some embodiments, the emotional state of the response may be expressed using different intonations or tones. For example, the generated response in text format is same for different emotional states, the intonations or tones for displaying the generated response in voice format are different. In some embodiments, when the emotional state is positive, the generated response may be spoken in a cheerful tone. When the emotional state is negative, the generated response may be spoken in a heavy or low tone.

In some embodiments, an indicator may be defined to represent a plurality of emotional states. For example, the indicator is “1” indicating that the emotion state is negative, and the indicator is “0” indicating that the emotional state is positive. For another example, the indicator may include a scale range from 1 to 10, indicating the emotion state from most negative to most positive. If the starting emotion state of the user is negative, the indicator of the emotional state of the response may change from 1 to 10 one by one along the whole dialogue.

For example, if the emotion recognition engine 403 detects that the emotion of the user is happy, the emotional state of the response of the character that the user talks to is adjusted to be happy. If the emotion recognition engine 403 detects that the emotion of the user is sad, the emotional state of the response of the character that the user talks to is adjusted to be sympathetic first, to warm and comfort the user. In the following dialogues, the emotional state of the response of the character that the user talks to is adjusted to become happy or optimistic progressively to elicit the positive emotion of the user, that is, to make the user to be no longer sad.

In some embodiments, after the generated response using the cloned character voice model corresponding to the identified character is displayed to the user, the user may continue the conversation with the same character or switch to talk to another character. When the conversation is over, the program can be continued to playback.

Comparing to the existing digital assistant system, for example, Alexa of Amazon, which builds a connection between a user and a device for general conversational purpose activity, based on the method for interaction consistent with the embodiments of the present disclosure, the QA TV builds connections between the user and millions of characters inside the TV program, where each connection represents a different story knowledge space. The “alive” characters are story smart, that is, the conversation is highly relevant to the character who is in conversation, which is not a general conversation engine (like Alexa) can handle. The character uses his/her voice in the TV program for the conversation with the user, which is different from the experience that Alexa (or Google assistant) provided using a single customized voice, thereby enhancing the experience of immersion of the user. Further, the response of the character is sensitive to the emotion of the user, that is, the answer may be different according to different current emotion of the user.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

In addition, each functional module or each feature of the device used in each of the embodiments may be implemented or executed by a circuit, which is usually one or more integrated circuits. The circuit designed to perform the functions described in the embodiments of the present disclosure may include a general-purpose processor, a digital signal processor (DSP), an application-specific integrated circuit (ASIC), or a general-purpose integrated circuit, a field programmable gate array (FPGA), or other programmable logic device, discrete gate or transistor logic, or a discrete hardware component, or any combination of the above devices. The general-purpose processor may be a microprocessor, or the processor may be an existing processor, a controller, a microcontroller, or a state machine. The above-mentioned general-purpose processor or each circuit may be configured by a digital circuit, or by a logic circuit. In addition, when an advanced technology that may replace current integrated circuit appears because of the improvement in semiconductor technology, the embodiments of the present disclosure may also use the integrated circuit obtained by the advanced technology.

The program running on the device consistent with the embodiment of the present disclosure may be a program that enables the computer to implement the function consistent with the embodiment of the present disclosure by controlling a central processing unit (CPU). The program or the information processed by the program may be temporarily stored in a volatile memory (such as a random-access memory RAM), a hard disk drive (HDD), a non-volatile memory (such as a flash memory), or other memory systems. The program for implementing the function consistent with the embodiments of the present disclosure may be stored on a computer-readable storage medium. Corresponding functions may be implemented by causing the computer system to read the program stored on the storage medium and execute the program. The so-called “computer system” herein may be a computer system embedded in the device, and may include an operating system or a hardware (such as a peripheral device).

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

What is claimed is:

1. A method for interaction, applied to a computing device, comprising:
in response to a user starting a conversation, detecting a current program watched by the user;
obtaining an input by the user and identifying a character that the user talks to based on the input;
retrieving script information of the detected program and a cloned character voice model corresponding to the identified character;
generating a response based on the script information corresponding to the identified character; and
displaying the generated response using the cloned character voice model corresponding to the identified character to the user.

2. The method according to claim 1, wherein detecting the current program watched by the user includes:
detecting the current program watched by the user based on a fingerprint library and a real time matching algorithm to detect a closest fingerprint detected in the fingerprint library that matches with the current program.

3. The method according to claim 1, wherein obtaining the input by the user and identifying the character that the user talks to based on the input includes:
converting a voice input by the user into a text and identifying the character that the user talks to based on the text.

4. The method according to claim 3, wherein:
converting the voice input by the user into the text includes converting the voice input into the text using a speech recognition model; and
identifying the character that the user talks to based on the text includes identifying the character from the text using a character recognition model.

5. The method according to claim 1, further comprising, before displaying the generated response using the cloned character voice model corresponding to the identified character to the user:
detecting a current emotion of the user; and
adjusting an emotion of the response to be displayed using the cloned character voice model based on the detected emotion of the user.

6. The method according to claim 5, wherein adjusting the emotion of the response to be displayed using the cloned character voice model based on the detected emotion of the user includes:
in response to the detected emotion of the user being positive, adjusting the emotion of the response to be displayed to be aligned with the detected emotion of the user.

7. The method according to claim 5, wherein adjusting the emotion of the response to be displayed using the cloned character voice model based on the detected emotion of the user includes:
in response to the detected emotion of the user being negative, adjusting the emotion of the response to be displayed to be empathy at first, and progressively transmitting the emotion of the response to be displayed to be positive.

8. The method according to claim 1, wherein the current program watched by the user includes a movie, a television (TV) show, a TV series, a TV drama, a TV program, a comedy, a soap opera, or a news program.

9. The method according to claim 1, wherein identifying the character that the user talks to based on the input includes:
displaying a list of candidate characters to the user; and
identifying the character according to a selection or confirmation of the user on the character in the list of the candidate characters.

10. The method according to claim 1, further comprising:
in response to the script information or the cloned character voice model being missing, displaying a notification to the user.

11. A device for interaction, comprising:
a memory; and
a processor coupled to the memory and configured to perform a plurality of operations comprising:
in response to a user starting a conversation, detecting a current program watched by the user;
obtaining an input by the user and identifying a character that the user talks to based on the input;
retrieving script information of the detected program and a cloned character voice model corresponding to the identified character;
generating a response based on the script information corresponding to the identified character; and
displaying the generated response using the cloned character voice model corresponding to the identified character to the user.

12. The device according to claim 11, wherein detecting the current program watched by the user includes:
detecting the current program watched by the user based on a fingerprint library and a real time matching algorithm to detect a closest fingerprint detected in the fingerprint library that matches with the current program.

13. The device according to claim 11, wherein obtaining the input by the user and identifying the character that the user talks to based on the input includes:
converting a voice input by the user into a text and identifying the character that the user talks to based on the text.

14. The device according to claim 13, wherein:
converting the voice input by the user into the text includes converting the voice input into the text using a speech recognition model; and
identifying the character that the user talks to based on the text includes identifying the character from the text using a character recognition model.

15. The device according to claim 11, wherein the plurality of operations performed by the processor further comprises, before displaying the generated response using the cloned character voice model corresponding to the identified character to the user:
detecting a current emotion of the user; and
adjusting an emotion of the response to be displayed using the cloned character voice model based on the detected emotion of the user.

16. The device according to claim 15, wherein adjusting the emotion of the response to be displayed using the cloned character voice model based on the detected emotion of the user includes:
in response to the detected emotion of the user being positive, adjusting the emotion of the response to be displayed to be aligned with the detected emotion of the user.

17. The device according to claim 15, wherein adjusting the emotion of the response to be displayed using the cloned character voice model based on the detected emotion of the user includes:
in response to the detected emotion of the user being negative, adjusting the emotion of the response to be displayed to be empathy at first, and progressively transmitting the emotion of the response to be displayed to be positive.

18. The device according to claim 11, wherein the current program watched by the user includes a movie, a television (TV) show, a TV series, a TV drama, a TV program, a comedy, a soap opera, or a news program.

19. The device according to claim 11, wherein identifying the character that the user talks to based on the input includes:
displaying a list of candidate characters to the user; and
identifying the character according to a selection or confirmation of the user on the character in the list of the candidate characters.

20. The device according to claim 11, wherein the plurality of operations performed by the processor further comprises in response to the script information or the cloned character voice models being missing, displaying a notification to the user.
